(19) United States
(12) Patent Application Publication
(10) Pub. No.: US 2009/0067096 A1
(43) Pub. Date: Mar. 12, 2009

(54) GIMBAL ASSEMBLY

(75) Inventor: Wayne A. Bonin, North Oaks, MN (US)

Correspondence Address: KINNEY & LANGE, P.A., 312 SOUTH 3RD STREET, THE KINNEY & LANGE BUILDING, MINNEAPOLIS, MN, 55415, US

(73) Assignee: SEAGATE TECHNOLOGY LLC, Scotts Valley, CA (US)

(21) Appl. No.: 11/851,202

(22) Filed: Sep. 6, 2007

(51) Int. Cl. G11B 5/48; G11B 21/16

(52) U.S. Cl. 360/245.3

(57) ABSTRACT

The present invention includes a gimbal having a plurality of forwards struts extending from a central portion of a transducer-carrying apparatus and terminating in a forward suspension attachment portion. A plurality of rear struts also extend from a central portion of the transducer-carrying apparatus and terminate in a rear suspension attachment portion. The width of the gimbal is narrower than the width of the supporting suspension. A method of making the gimbal includes photo-patterning a foil substrate with an insulative material in the shape of struts. Bond pads are plated onto the foil substrate, which serve as the forward and rear attachment portions to the suspension, as well as attachment portions to the transducer-carrying apparatus. Supportive gimbal springs are etched onto the insulative undercoat of the foil substrate.

### BACKGROUND

The present invention relates generally to disc drives, and more specifically to an improved gimbal assembly for supporting a transducer relative to a disc surface.

Disc drive systems typically contain a plurality of stacked discs capable of storage of digital information. Each disc has several data tracks, which are concentrically arranged. The common shaft upon which the discs are stacked is driven by a spindle motor, which causes the discs to spin. Each assembly has an accompanying actuator mechanism for navigation of the several data tracks. The actuator has a track-accessing arm that is controlled by electronic circuitry. On the end of the arm is a suspension, which carries a gimbal. This gimbal holds and supports a slider that carries a transducer. As the storage discs spin, the transducer is used to write and read data to and from each disc.

A narrow distance between the disc surface and the slider is critical to success of the write and read functions of the drive. To maintain this narrow distance, the gimbal provides sufficient flexibility to allow the slider to pitch and roll so it may follow the topography of the spinning disc. The spinning of the disc also generates windage as air is dragged across the surface of the head. This windage, or high velocity airflow, can create forces that adversely affect the desired position of the slider, which can interfere with proper tracking.

Another common problem affecting disc drives occurs when there is reverse rotation of the disc. This can happen during manufacture, shipping, or other movement of the drive. In most designs, reverse rotation of the disc has the potential to cause the gimbal to buckle and deform, resulting in permanent damage to the drive.

Conventional gimbals have a cantilever beam structure which makes them particularly susceptible to reverse buckling. One way to guard against this is to increase the gimbal width or stiffness, but this is at odds with the desire to allow pitch and roll flexibility. Increased gimbal width also increases windage and limits the usable disc area for data storage.

Embodiments of the present invention address these and other problems, and offer advantages over the prior art.

### SUMMARY

The present invention relates to a gimbal having a plurality of forward struts extending from a central portion of a transducer-carrying apparatus and terminating in a forward suspension attachment portion. A plurality of rear struts also extend from a central portion of the transducer-carrying apparatus and terminate in a rear suspension attachment portion. The width of the gimbal is narrower than the width of the supporting suspension.

A method of making the gimbal includes photo-patterning a foil substrate with an insulative material in the shape of struts. Bond pads are plated onto the foil substrate, which serve as the forward and rear attachment portions to the suspension, as well as attachment portions to the transducer-carrying apparatus. Supportive gimbal springs are etched onto the insulative undercoat of the foil substrate.

### BRIEF DESCRIPTION OF THE DRAWINGS

FIG. 1 is an isometric view of a disc drive.

FIG. 2a is a top view of a suspension assembly that may be used in a disc drive as is shown in FIG. 1.

FIG. 2b is a side view of the suspension assembly shown in FIG. 2a.

FIG. 3 is an isometric view of a gimbal attached to a slider according to an embodiment of the present invention.

FIG. 4 is an isometric view of a gimbal attached to a slider according to an alternative embodiment of the present invention.

FIGS. 5a-5l are diagrams illustrating the steps of a manufacturing process for producing a gimbal according to an embodiment of the present invention.

FIG. 6 is a graphical display from a simulation showing a pitch stiffness vs. pitch angle for the gimbal shown in FIG. 3.

FIG. 7 is a graphical display from a simulation showing roll stiffness vs. roll angle for the gimbal shown in FIG. 3.

FIG. 8 is a graphical display from a simulation showing gimbal unload displacement vs. load force applied for the gimbal shown in FIG. 3.

FIG. 9 is a graphical display from a simulation showing forward and reverse buckling stress vs. load force for the gimbal shown in FIG. 3.

FIG. 10 is a graphical display from a simulation showing side buckling stress vs. load force for the gimbal shown in FIG. 3.

### DETAILED DESCRIPTION

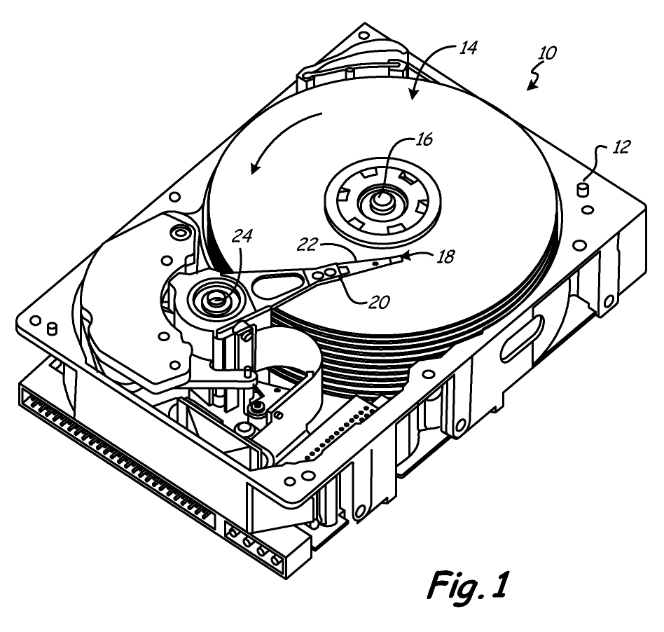

FIG. 1 is an isometric view of disc drive 10 in which the present invention would be useful. Disc drive 10 includes drive housing 12. Inside drive housing 12 resides disc stack 14. Disc stack 14 sits on spindle 16, which rotates, and is powered by a spindle motor (not visible). Disc stack 14 is comprised of a plurality of individual discs, each surface having its own slider 18 for reading and writing. Each slider 18 is supported by a suspension 20, which is attached to and positioned by an actuator arm 22. Not visible in this figure is the gimbal, which is located between slider 18 and suspension 20. Actuator arm 22 rotates about pivot shaft 24 to allow slider 18 to move to and communicate with the proper data tracks.

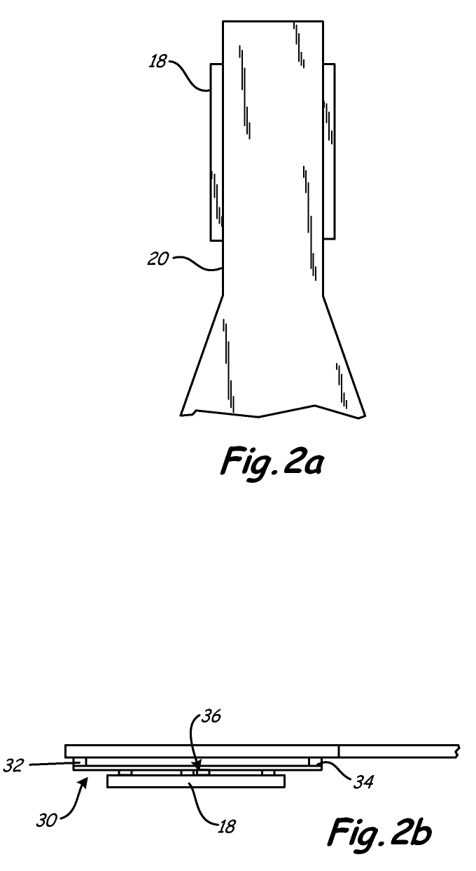

FIG. 2a is a top view of a suspension assembly attached to the slider. In this figure, suspension 20 is attached to the gimbal (not pictured), which carries slider 18. It is beneficial that suspension 20 does not extend outside of the width of the slider 18, as this could cause the suspension to act like wings and cause slider 18 to fly erratically above the surface of the disc. The decreased width of suspension 20 also increases the amount usable disc area available for data storage.

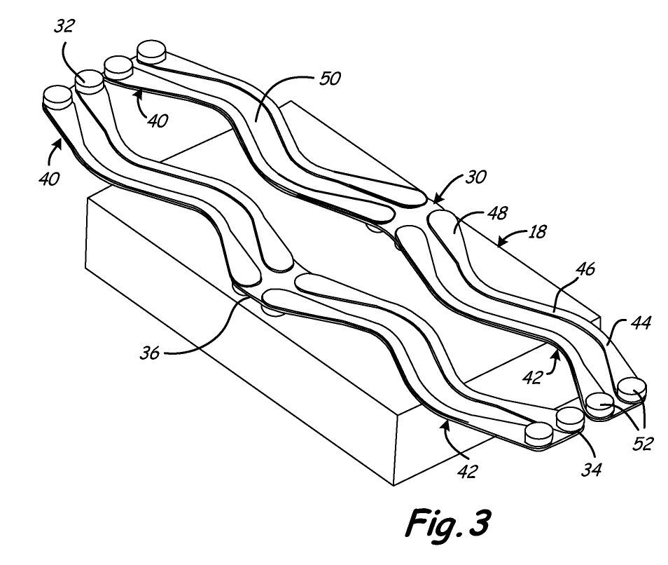

FIG. 2b is a side view of the end of the suspension assembly pictured in FIG. 2a. Located between suspension 20 and slider 18 is gimbal 30. Gimbal 30 (described in detail below and shown in FIGS. 3-4) includes forward suspension attachment portion 32 and rear attachment portion 34. Slider attachment portion 36 connects gimbal 30 to slider 18. Gimbal 30 allows slider 18 to pitch and roll in order to conform to the topography of the rotating disc, while at the same time maintaining resistance to buckling.

FIG. 3 illustrates gimbal 30 attached to slider 18. Gimbal 30 includes forward gimbal struts 40 and rear gimbal struts 42. The main support for each strut is a plurality of metallic gimbal springs 44, which double as electrical interconnects. Metallic gimbal springs 44 may be constructed from a conductor such as a copper alloy, and transmit electrical signals to and from a transducer (not shown) carried by slider 18 as the disc is read from or written to. This dual purpose obviates the necessity of adding wires to carry the electrical signals between slider 18 and the disc drive circuitry. The structure of gimbal springs 44 enhances their mechanical efficacy. Because there are stress concentrations at the edges of gimbal springs 44, they can be made significantly narrower in the middle (gimbal spring narrow portion 46) and wider at the ends (gimbal spring wide portion 48). This provides maximum flexibility for a low pitch and roll stiffness, while maintaining strong resistance to unwanted forces that would interfere with the ability of slider 18 to track properly.

A thin photo-patterned insulation layer 50 supports the individual gimbal elements, and also provides insulation between gimbal springs 44. Insulation layer 50 both increases sway stiffness and aids in the handling of slider 18 during drive assembly. In FIG. 3, both forward and rear suspension attachment portions 32, 34 are visible. These are connectable to suspension 20 (FIG. 2b) by means of a plurality of bond pads 52. Bond pads 52 can also be employed at slider attachment portion 36 to connect gimbal 30 to slider 18.

An alternative embodiment of gimbal strut construction is a laminated metallic structure. Some highly conductive but weaker metals employed in gimbal springs 44 may not have the desired mechanical strength characteristics for a particular application. To solve this issue, a multi-layered approach may be utilized. The outer layers are comprised of a high strength material such as stainless steel or titanium, with the inner layer comprised of a highly conductive substance such as pure copper. The outer layers then supply the necessarily mechanical support, with the inner layers providing the electrical conductivity necessary for functional electrical interconnects.

As shown in FIG. 3, gimbal 30 utilizes a serpentine strut structure. The curves in gimbal springs 44 increase flexibility by reducing the tensile forces that build up as slider 18 pitches and rolls. Depending on the relative importance of gimbal flexibility in a particular application, the amount of curvature can be varied or even eliminated to yield a straight strut structure. Straight struts give the highest resonant mode frequencies, which guard against buckling, sway, and other undesired motion, but also restrict the ability of slider 18 to pitch and roll by increasing stiffness. For even higher resistance to sway, the suspension attachment portions of forward and rear gimbal struts 40, 42 can be spread further apart. This increases resonant mode frequencies while having little effect on pitch and roll stiffness, and only slightly reducing accessible disc area. The small width of gimbal 30 shown in FIG. 3 is made possible by low gimbal spring thickness, and renders a greater portion of the disc usable for storage.

Due to the abandonment of the traditional cantilever structure in the design shown in FIG. 3, forward and reverse buckling resistance is particularly high. If slider 18 is forced either forwards or backwards, half of gimbal 30 will always be in tension, and the other half in compression. This provides a significant defense against any catastrophic buckling failure.

FIG. 4 is a diagram illustrating an alternative embodiment of gimbal 30a attached to slider 18. Gimbal 30a includes central slider attachment portion 60, which is comprised of forward and rear central slider attachment portions 62, 64, as well as a plurality of additional bond pads 66. Forward and rear slider attachment portions 62, 64 are connected to slider 18 at additional bond pads 66, thereby increasing overall area of attachment. This modification is made primarily to maintain the pitch alignment of slider 18 during the assembly process, but there is also a secondary benefit of increased attachment strength.

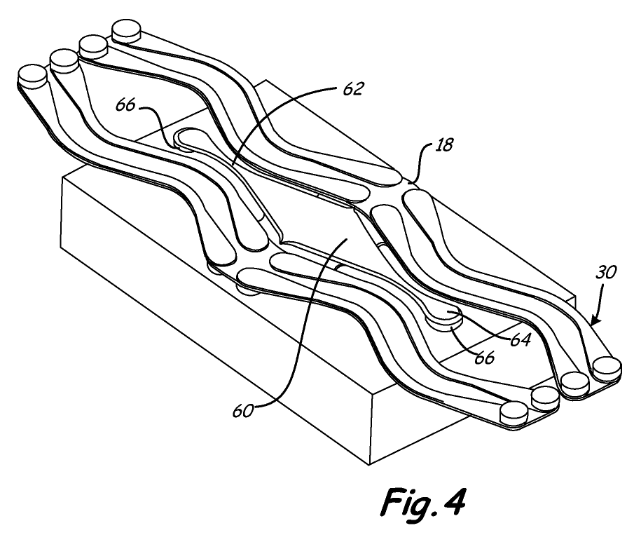

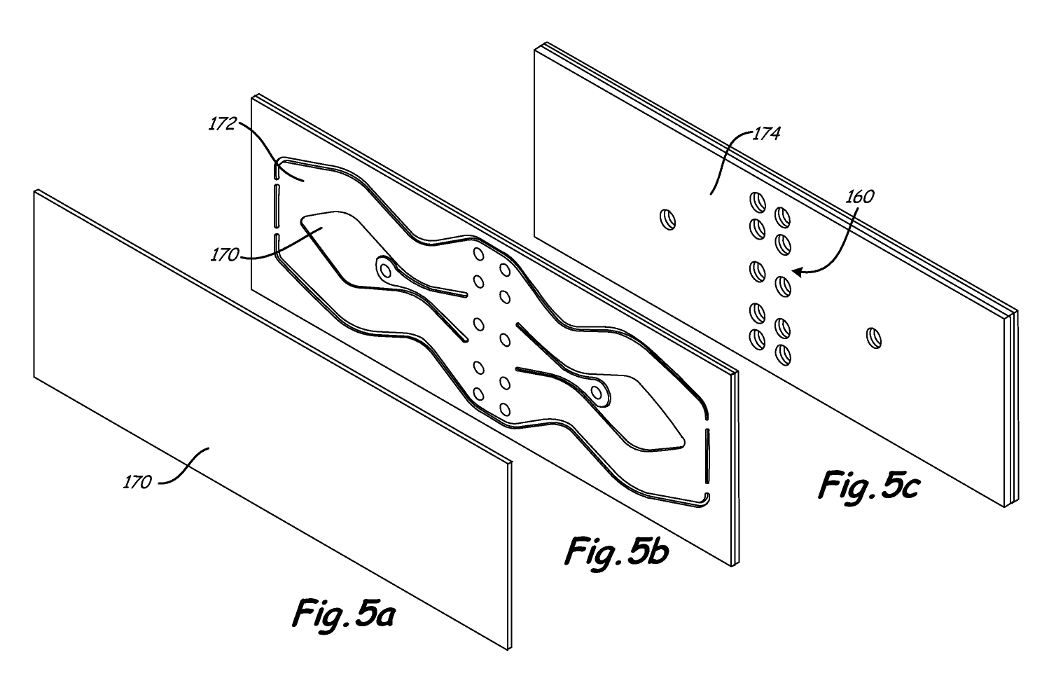

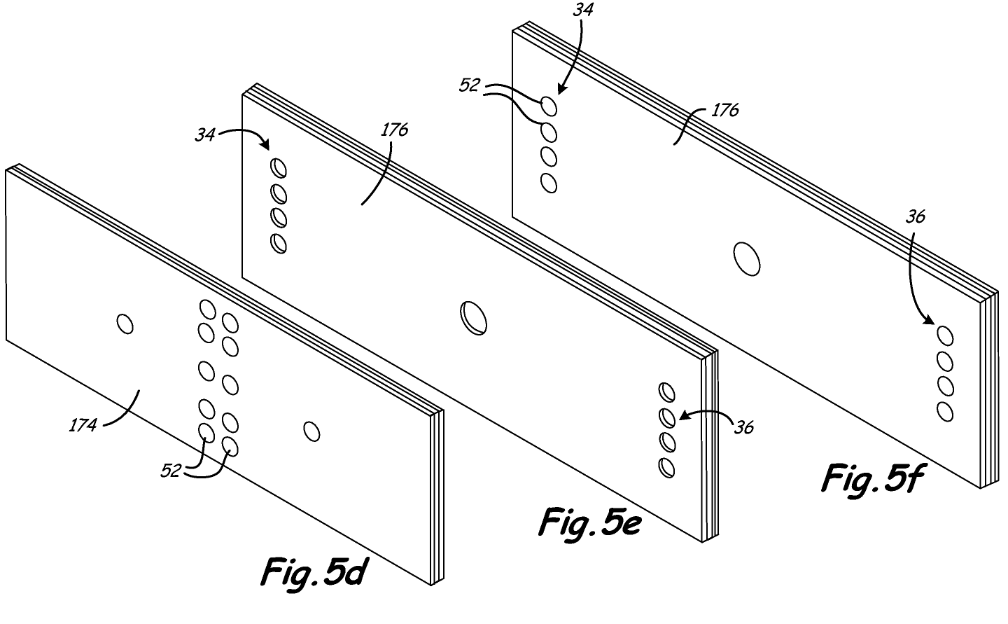

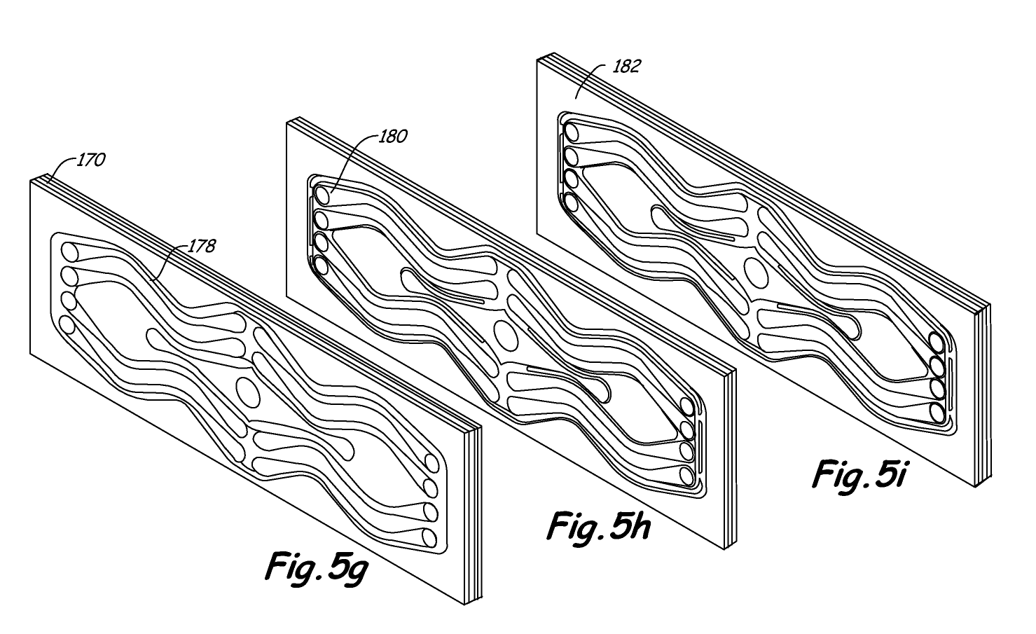

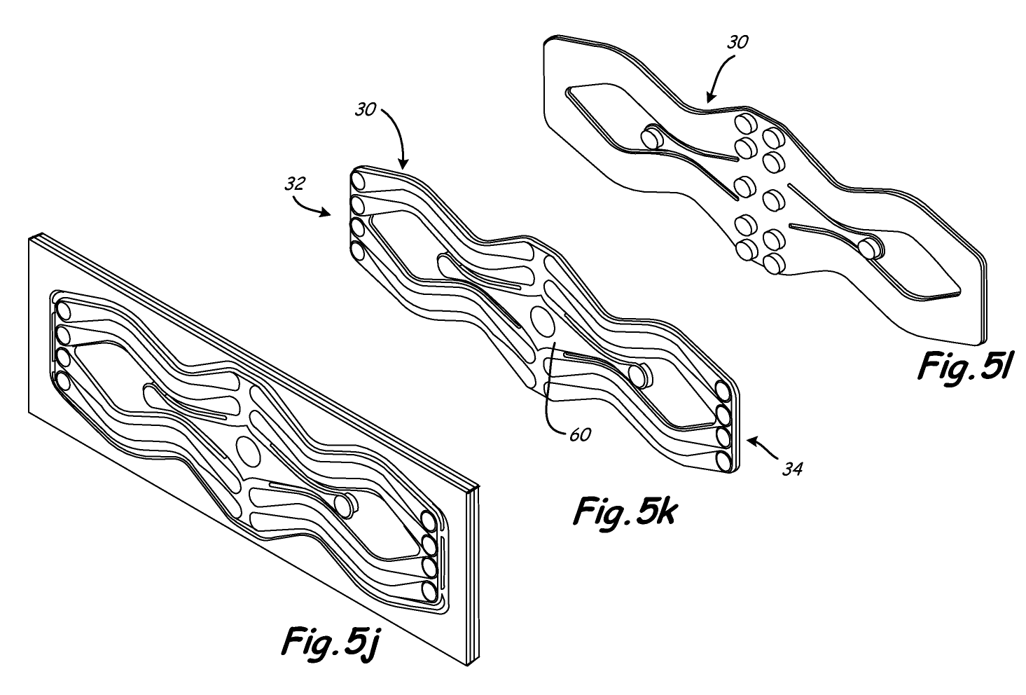

FIGS. 5a-5l are diagrams illustrating an exemplary method for manufacturing gimbal 30a. FIG. 5a is an isometric view of bare foil substrate 170. Metallic foil 170 acts as a substrate for initial photo patterning.

FIG. 5b illustrates foil substrate 170 with a photo patterned insulation undercoat 172. Undercoat 172 may be an insulator such as polyimide or benzocyclobutene.

FIG. 5c illustrates foil substrate 170 with plating mask 174 applied. Plating mask 174 is used for the plating of bond pads 52. The visible bond pads 52 are for central slider attachment portion 60.

FIG. 5d shows substrate 170 with slider bond pads 52 plated over plating mask 174. The plating mask is later removed.

The same process is then repeated for the reverse side. FIG. 5e depicts this reverse view of the substrate with applied plating mask 176 for bond pads 52 used in forward and rear suspension attachment portions 34, 36.

FIG. 5f depicts the same view as in FIG. 5e with suspension bond pads 52 plated.

FIG. 5g shows the substrate with etch pattern 178 applied. This pattern is applied to define the etching of future gimbal springs 44.

FIG. 5h shows the etched gimbal spring pattern 178, which leaves etched gimbal springs 180.

The next step is to apply insulation cover coat 182 to gimbal 30, as shown in FIG. 5i. Cover coat 182 is applied directly atop etched gimbal springs 180.

FIG. 5j shows gimbal 30 completed in its frame. In this step, slider bond pad plating mask 176 has been removed.

With all necessary machining done, completed gimbal 30 is finally removed from the frame. FIGS. 5k and 5l show the top and bottom isometric views of finished gimbal 30.

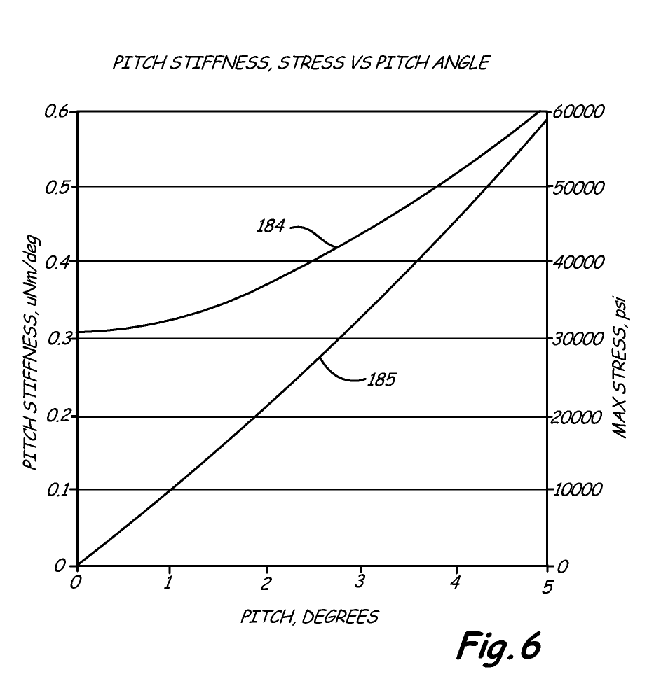

Many of the beneficial characteristics of gimbal 30 are evident in view of its performance in various simulations. FIG. 6 is a graphical display illustrating simulated pitch stiffness and stress versus pitch angle. Expectedly, as the pitch angle of gimbal 30 increases, pitch stiffness is negatively affected and increases. Pitch stiffness line 184 exhibits this activity. A pitch angle exceeding 3 degrees is fairly extreme, and will not likely occur in most applications. Nonetheless, the present invention performs well at this pitch angle and beyond, maintaining low pitch stiffness throughout the first several degrees of inflection. Stress line 185 is shown to indicate which materials are suitable and will not permanently deform at expected pitch angles for a particular device. Stainless steel, for example, has a maximum stress level of approximately 200,000 psi, resulting in no foreseeable stress issues.

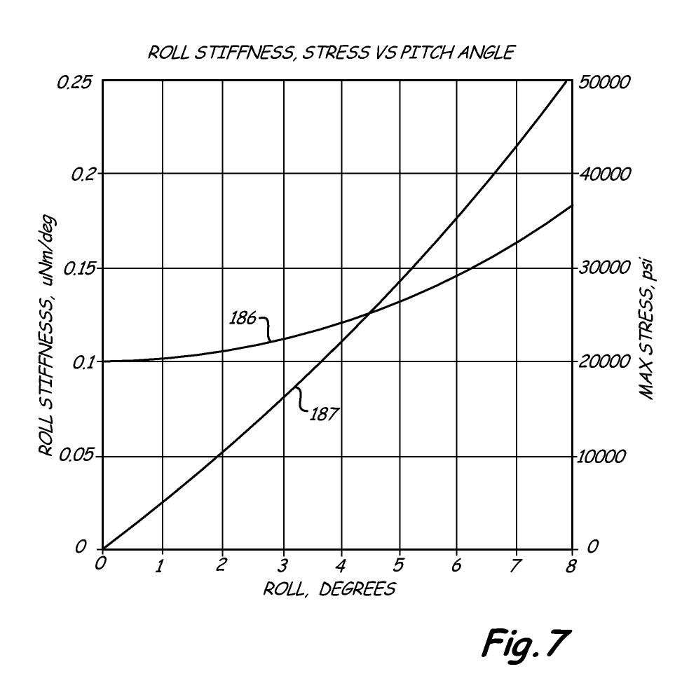

FIG. 7 is a graphical display illustrating gimbal roll stiffness and stress versus gimbal roll angle. Again it is apparent from roll stiffness line 186 that the present gimbal design performs well despite quick increases in roll angle. A low roll stiffness is maintained throughout, and the maximum stress foreseen does not approach problem ranges. Stress line 187 again shows that the maximum stress levels likely to be reached will be easily handled by most materials.

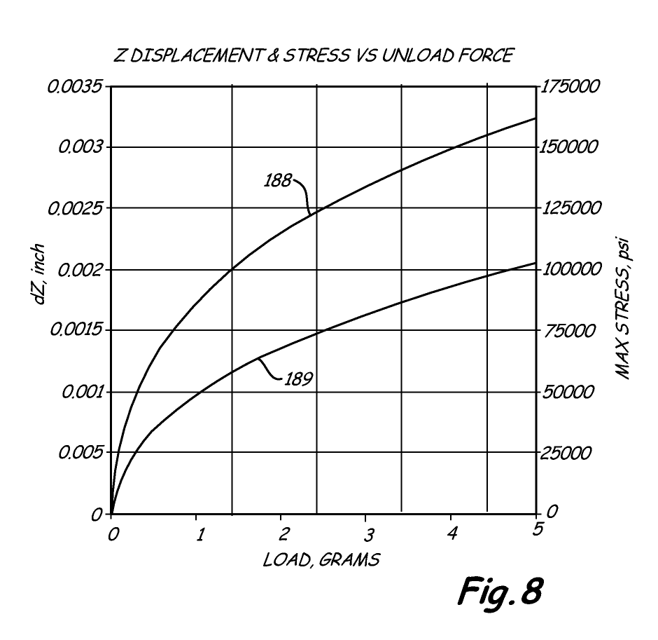

FIG. 8 is a graphical display illustrating the performance of gimbal 30 during unloading from the disc. The graph shows Z displacement and stress versus unload force. During unloading, suction between the disc surface and the head can occur, and the resulting vacuum must be broken without damage occurring to the gimbal. Gimbal displacement (shown by displacement line 188) for the present gimbal design is still well within acceptable levels of a few thousandths of an inch. Additionally, maximum stress is also within acceptable levels for most materials. Actual unload displacement is not expected to be more than one or two grams, meaning maximum stress (shown by stress line 189) would probably not exceed 70,000 psi.

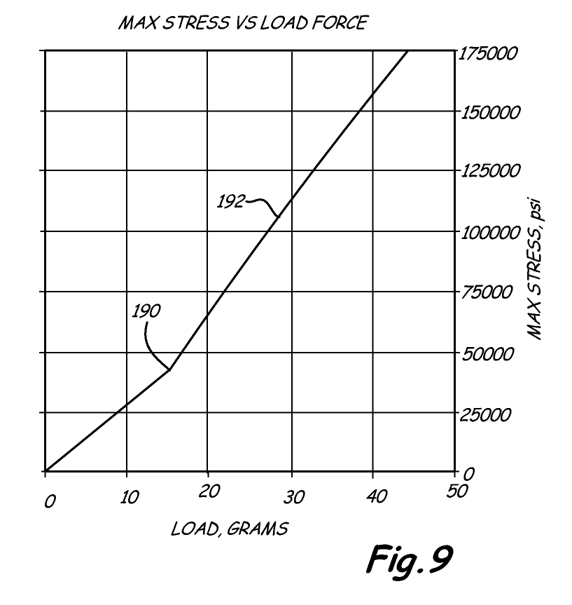

FIG. 9 is a graphical display illustrating forward and reverse buckling stress versus load force for gimbal 30. Because the present gimbal design is symmetrical, forward and reverse buckling strengths are identical. This is one area where there have been significant improvements over the prior art. Due to the structure of gimbal 30, if one side buckles under a high load force, the other side will always remain in tension. The buckling point is observable at point 190. In the prior art, once buckling occurred, there was a catastrophic failure and deformation followed. In the present gimbal design, since either the forward or reverse struts will remain in tension, such an event will not occur. Desired buckling resistance is in the range of approximately 20 to 30 grams of load force, and this results in maximum stress levels (shown by stress line 192) that are still within suitable ranges for the desired materials to be used.

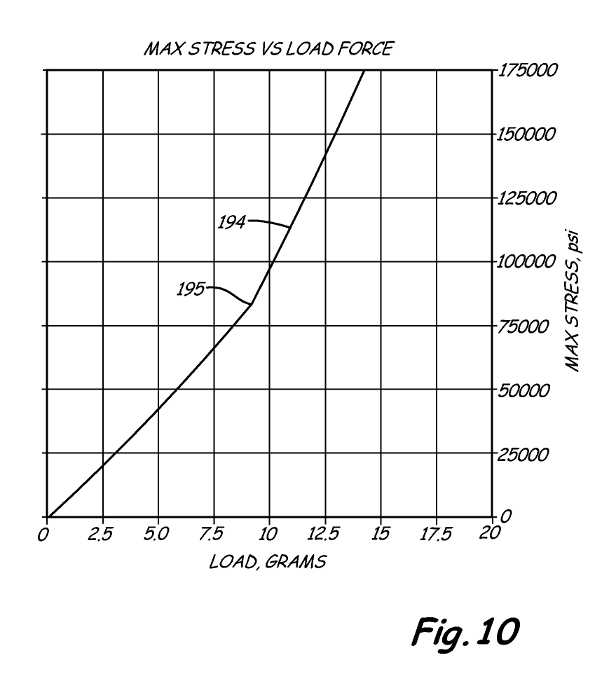

FIG. 10 depicts side-buckling stress vs. load force. This stress occurs when the slider moves right or left across its x-axis. Again, left and right side-buckling strengths are identical because of the symmetrical design of the gimbal. Stress line 194 shows the side-buckling stress value. Buckling in this direction, observable at point 195, is less common than forward or reverse buckling, but the data still shows that a significant load force will be required to induce any kind of failure in the x direction.

In summary, the present invention relates to a gimbal used for supporting a transducer carrying apparatus and having a plurality of forward gimbal struts extending from a central portion of the transducer-carrying apparatus to a forward attachment portion of a suspension, and a plurality of rear gimbal struts, also extending from the central portion of a transducer-carrying apparatus to the suspension. This design provides improved resistance to buckling and desirable stiffness characteristics.

Although the present invention has been described with reference to preferred embodiments, workers skilled in the art will recognize that changes may be made in form and detail without departing from the spirit and scope of the invention.

1. A gimbal for supporting a transducer-carrying apparatus, comprising:
a plurality of forward struts extending from a central portion of the transducer-carrying apparatus to a forward attachment portion for connection to a suspension; and
a plurality of rear struts extending from the central portion of the transducer-carrying apparatus to a rear attachment portion for connection to the suspension.

2. The gimbal of claim 1, wherein the width of the plurality of forward struts, the plurality of rear struts, and the suspension combined is narrower than the width of the transducer-carrying apparatus.

3. The gimbal of claim 1, wherein the plurality of forward struts comprises two symmetrical forward struts and the plurality of rear struts comprises two symmetrical rear struts extending from the transducer-carrying apparatus to the suspension.

4. The gimbal of claim 1, wherein the plurality of forward struts and the plurality of rear struts have a serpentine structure.

5. The gimbal of claim 1, wherein the plurality of forward struts and the plurality of rear struts include:
an insulative support structure; and
a plurality of metallic gimbal springs.

6. The gimbal of claim 5, wherein the insulative support structure is composed of polyimide or benzocyclobutene.

7. The gimbal of claim 5, wherein the metallic gimbal springs have a width that is less at a central portion of the gimbal springs than at an end portion of the gimbal springs.

8. The gimbal of claim 1, wherein the struts have a laminated structure, comprising:
a top and bottom layer composed of a mechanically supportive material; and
a middle layer composed of a conductive material.

9. The gimbal of claim 8, wherein the mechanically supportive material has a yield stress of at least 100,000 psi.

10. The gimbal of claim 1, wherein a plurality of bond pads attach the plurality of forward struts and the plurality of rear struts to the central portion of the transducer-carrying apparatus.

11. The gimbal of claim 1, wherein a plurality of bond pads attach the gimbal to the suspension at the forward and rear attachment portions.

12. The gimbal of claim 9, further comprising a central attachment feature for attaching the gimbal to the transducer-carrying apparatus

13. A method of making a gimbal for supporting a transducer-carrying apparatus comprising:
photo-patterning a foil substrate with an insulative undercoat in the shape of struts;
plating first bond pads for attachment to the transducer-carrying apparatus on the insulative undercoat opposite the foil substrate in a central portion of the struts;
plating second bond pads for attachment to a suspension on the foil substrate at end portions of the struts; and
etching the foil substrate to form patterned metallic gimbal springs on the insulative undercoat.

14. The method of claim 12, wherein an insulative cover coat is applied to the patterned metallic gimbal springs.

15. The method of claim 12, further comprising:
applying a plating mask for transducer-carrying apparatus bond pads on the foil substrate;
plating the transducer-carrying apparatus bond pads; and
removing the plating mask.

16. The method of claim 12, further comprising:
applying a plating mask for forward and rear suspension attachment bond pads on the foil substrate;
plating the forward and rear suspension attachment bond pads; and
removing the plating mask.

17. The method of claim 12, wherein an etching photo-pattern is applied to the substrate prior to etching.

18. The method of claim 12, wherein the insulative material is polyimide or benzocyclobutene.

19. The method of claim 12, wherein the struts have a width narrower than the width of the transducer-carrying apparatus.

20. The method of claim 12, further comprising:
etching a central transducer-carrying apparatus attachment portion; and
plating third bond pads for attachment of the attachment portion to the transducer-carrying apparatus.
